(19) United States
(12) Patent Application Publication
(10) Pub. No.: US 2014/0301304 A1
(43) Pub. Date: Oct. 9, 2014

(54) Resource Control

(71) Applicant: Broadcom Corporation, Irvine, CA (US)

(72) Inventors: Keiichi KUBOTA, Surrey (GB); Brian MARTIN, Surrey (GB); Himanshu KUMAR, Hampshire (GB)

(21) Appl. No.: 14/245,314

(22) Filed: Apr. 4, 2014

(30) Foreign Application Priority Data
Apr. 5, 2013 (GB) 1306206.2

(51) Int. Cl. H04W 74/08

(52) U.S. Cl. CPC H04W 74/0833
USPC 370/329

(57) ABSTRACT

Measures including, methods, apparatus, computer software and computer program products, for use in radio resource control in a cellular communications network. At a user equipment, a first random access channel (RACH) message is generated. The user equipment causes transmittal, on a RACH, of the first RACH message. The first RACH message comprises an indication that at least a second RACH message associated with the first RACH message is to be transmitted subsequently from the user equipment on the RACH.

### TECHNICAL FIELD

The present invention relates to resource control. In particular, but not exclusively, the present invention relates to measures, including methods, apparatus and computer software, for use in radio resource control in a cellular communications network.

### BACKGROUND

In the last several 3rd Generation Partnership Project (3GPP) Radio Access Network Working Group 2 (RAN2) meetings. Cell update message size limitation issue has been discussed. Uplink (UL) Common Control Channel (CCCH) messages are transmitted over Random Access Channel (RACH) resources and the message cannot be segmented such that the maximum UL CCCH message size is determined by the RACH transport block size. In practice, the RACH transport block size is set to 168 bits. A 2-bit Medium Access Control (MAC) header is added on top of the Radio Resource Control (RRC) UL CCCH message size itself. Therefore, the maximum UL CCCH message size would be 166 bits in the field. Due to the RRC message contents which need to be encoded, particularly in RRC Connection Request and Cell Update messages, and which have been extended over multiple 3GPP releases, the cell update message has already reached its maximum size and so any additional information cannot be added in the cell update message anymore. However some network (NW) vendors expect user equipment (UE) to signal RACH measured results in the Cell Update message (see for example R2-130201) and RRC Connection Request message. The above issues are further discussed in R2-125690.

Various approaches for tackling the above issues have been proposed. One approach is given in R2-125951; however, this approach has at least one problem in that the UE will not be able to signal any additional information in a cell update message. Another approach is given in R2-130201, where it was proposed to omit 3GPP Release 1999 (R99) extensions and Multimedia Broadcast and Multicast Service (MBMS) Information elements (IEs) to include the measured results on RACH. A further approach is given in R2-130481 where it was proposed to omit all capabilities if a UE performs the cell update on the same cell as before.

Additionally, as part of 3GPP Release 12 (Rel-12) Machine Type Communication (MTC) work, solutions are being studied to try and develop a more efficient method to transfer small amounts of data, reducing power consumption and signalling overhead (for example, smart meter information). In the current version of 3GPP Technical Report (TR) 23.887, one solution is identified (see Ch. 5.1.1.3.6.3, “Connectionless Data Transmission”) which requires that the UE is assigned a “connection ID” which it passes to the NW when radio resources are allocated for the transmission of data, without the need to send a SERVICE REQUEST.

It would therefore be desirable to solve at least some of the problems outlined above.

### BRIEF DESCRIPTION OF THE DRAWINGS

FIG. 1 shows a message flow diagram according to embodiments;

FIG. 2 shows a message flow diagram according to embodiments;

FIG. 3 shows a flow diagram according to embodiments;

FIG. 4 shows a flow diagram according to embodiments; and

FIG. 5 is a simplified block diagram of various example electronic devices and/or apparatus which are suitable for use in practicing embodiments.

### DETAILED DESCRIPTION

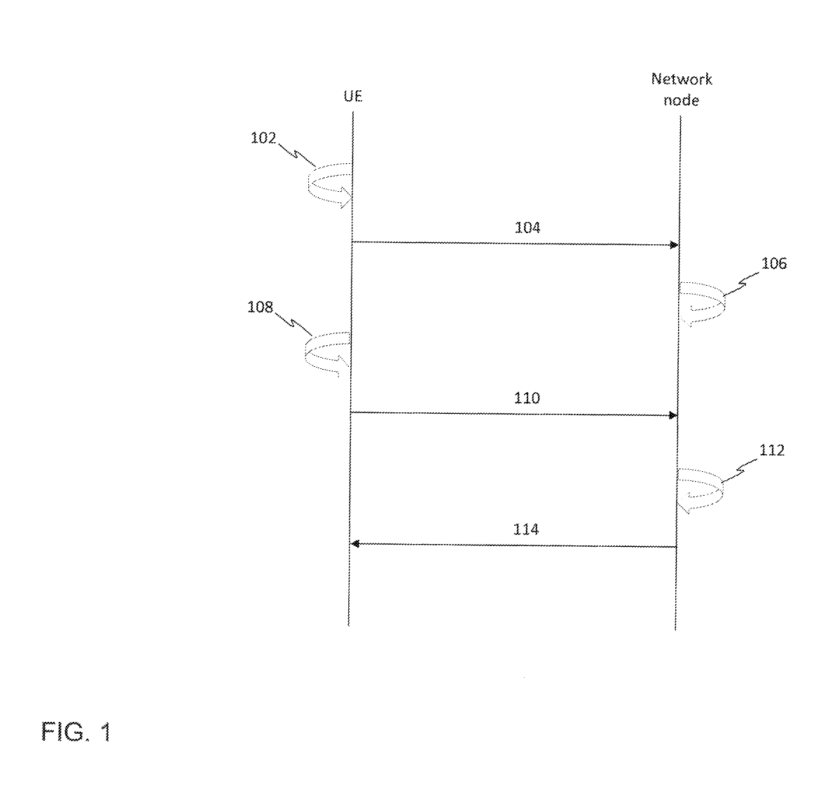

FIG. 1 shows a message flow diagram according to embodiments. In particular, FIG. 1 shows messages flowing in-between a UE and network node of a cellular communications network and tasks performed at the UE and network node. The cellular telecommunications network may for example comprise a Long Term Evolution (LTE) or Long Term Evolution Advanced (LTE-A) network. The network node may for example comprise an evolved Node B (eNB), a radio network controller (RNC) and/or or other node of the cellular telecommunications network. The UE may for example comprise a mobile (or ‘cellular’) telephone.

According to a first aspect of the present invention, there is provided a method for use in radio resource control in a cellular communications network, the method comprising, at a user equipment:

generating a first random access channel (RACH) message; and

causing transmittal, on a RACH, of the first RACH message,
wherein the first RACH message comprises an indication that at least a second RACH message associated with the first RACH message is to be transmitted subsequently from the user equipment on the RACH.

According to a second aspect of the present invention, there is provided apparatus for use in radio resource control in a cellular communications network, the apparatus comprising a processing system configured to, at a user equipment:

generate a first random access channel (RACH) message; and

cause transmittal, on a RACH, of the first RACH message,

wherein the first RACH message comprises an indication that at least a second RACH message associated with the first RACH message is to be transmitted subsequently from the user equipment on the RACH.

According to a third aspect of the present invention, there is provided a method for use in radio resource control in a cellular communications network, the method comprising, at a network node:

receiving, on a random access channel (RACH), a first RACH message generated by a user equipment, the first RACH connection request message comprising an indication that at least a second RACH message associated with the first RACH message is to be transmitted subsequently from the user equipment on the RACH.

According to a fourth aspect of the present invention, there is provided apparatus for use in radio resource control in a cellular communications network, the apparatus comprising a processing system configured to, at a network node:

receive, on a random access channel (RACH), a first RACH message generated by a user equipment, the first RACH connection request message comprising an indication that at least a second RACH message associated with the first RACH message is to be transmitted subsequently from the user equipment on the RACH.

According to a fifth aspect of the present invention, there is provided computer software configured to perform the method of the first or third aspects of the present invention.

Embodiments comprise a computer program product comprising a non-transitory computer-readable storage medium having computer readable instructions stored thereon, the computer readable instructions being executable by a computerized device to cause the computerized device to perform the method of the first or third aspects of the present invention.

Further features and advantages of the invention will become apparent from the following description of preferred embodiments of the invention, given by way of example only, which is made with reference to the accompanying drawings.

Embodiments comprise measures, including methods, apparatus and computer software, for use in radio resource control in a cellular communications network. At a UE, a first random access channel (RACH) message is generated 102 and the UE causes causing transmittal 104, on a RACH, of the first RACH message. The first RACH message comprises an indication that at least a second RACH message associated with the first RACH message is to be transmitted subsequently from the user equipment on the RACH.

In embodiments, the first RACH message comprises an identifier identifying at least the first RACH message and the second associated RACH message as being a sequence of RACH messages. In embodiments, the identifier comprises an identifier for the UE.

In embodiments, the first RACH message generated by the UE and transmitted into the cellular telecommunications network is received at a network node. In embodiments, in response to receipt of the first RACH message, the network node utilizes 106 at least some of the content of the first RACH message in radio resource control.

In embodiments, the UE generates 108 the second associated RACH message, and causes transmittal 110 of the generated second associated message on the RACH. In embodiments, the second associated RACH message comprises the identifier identifying at least the first RACH message and the second associated RACH message as being a sequence of RACH messages.

In embodiments, where the identifier is comprised in both the first and second associated RACH message and the identifier comprises an identifier for the UE, when the NW node receives the second associated RACH message, the UE ID (contained in both messages) or another newly defined identifier (which identifies the UE and the connection attempt) can be used by the NW node to combine the information. In such embodiments, the NW node knows which UE the first and second associated RACH message came from.

In embodiments, the second RACH message generated by the UE and transmitted into the cellular telecommunications network is received at the network node. In embodiments, in response to receipt of the second associated RACH message, the network nodes utilizes 112 at least some of the content of the first RACH message and/or the second associated RACH message in radio resource control.

Embodiments comprise the network node determining, on the basis of the identifier comprised in the second associated RACH message, that the first RACH message and the second associated RACH message form a sequence of RACH messages transmitted from the user equipment. In the network node, the two or more RACH messages can be matched together using the identifier, for example identifier associated with the UE.

In embodiments, the network node utilizes at least some of the content of the first RACH message and at least some of the content of the second associated RACH message in radio resource control.

In embodiments, the identifier identifies how many RACH messages are in the sequence of RACH messages. For example the identifier may indicate that the sequence of RACH messages comprises only two RACH messages, i.e. the first and second associated RACH messages, or may indicate that the sequence of RACH messages has one or more further RACH messages in addition to the first and second associated RACH messages which are to be transmitted from the UE.

In embodiments, the second associated RACH message comprises an indication that at least a third RACH message associated with the first RACH message and the second associated RACH message is to be transmitted subsequently from the UE on the RACH.

In embodiments, the first RACH message comprises data associated with one or more communication capabilities of the user equipment.

In embodiments, the second associated RACH message comprises data associated with one or more measurements performed by the user equipment. In embodiments, the data associated with the one or more measurements performed by the user equipment comprises data associated with the one or more measurements performed by the user equipment in relation to the RACH.

In embodiments, the first RACH message does not comprise any data associated with any measurements performed by the user equipment

In embodiments, the first RACH message comprises a radio resource control (RRC) connection request message. In embodiments, the UE indicates in the RRC Connection Request message that at least one further RACH message follows (e.g. using spare bits, in UTRAN or EUTRAN). In embodiments, the UE transmits a second message on the RACH containing further data (e.g. using a new RACH message type which contains measured results on RACH, or container for small data). The second message may also indicate that more data follows in one or more further RACH messages. The indication may be a number which indicates how many messages altogether (in case of out of sequence delivery at the NW node) are in the RACH message sequence.

In embodiments, the RRC Connection Request (and in other embodiments, possibly also a Cell Update message) is divided into two separate RACH messages. In embodiments, the first RACH message contains all the UE capabilities and a new flag indicating that measurements are being sent in a second associated RACH message. In embodiments, the second associated RACH message contains all the RACH measurements performed by the UE.

In some embodiments, in response to receipt of the second associated RACH message, the network node transmits 114 a RRC connection reject message to the UE. In other embodiments, in response to the receipt of the second associated RACH message, the network node transmits 114 a RRC connection setup message to the UE.

In embodiments, one or more of the RRC connection reject message and the RRC connection setup message transmitted from the network node to the UE comprises data associated with a redirection or handover to a different cell, carrier frequency or radio access technology (RAT).

In embodiments, in response to receipt of the second associated RACH message, the network node determines 112 that a redirection or handover to a different cell, carrier frequency or radio access technology should be performed in relation to the user equipment, such that the transmitted 114 RRC connection setup message comprises data associated with the redirection or handover to a different cell, carrier frequency or radio access technology.

In embodiments, in response to receipt of the second associated RACH message, the network node determines 112 that a redirection or handover to a different cell, carrier frequency or radio access technology should be performed in relation to the user equipment, such that the transmitted 114 RRC connection reject message comprises data associated with the redirection or handover to a different cell, carrier frequency or radio access technology.

In embodiments, in response to receipt of the first RACH message, the network node prioritizes contention resolution and/or resource allocation for the user equipment.

In embodiments, the first RACH message comprises an establishment cause indicator indicating the cause of generation of the first RACH message and/or the second associated RACH message by the user equipment.

In embodiments, in response to a predetermined period of time passing after transmittal of the first RACH message without receipt of a RRC connection setup message, the UE causes transmission of the second associated RACH message; in such embodiments, a first transmission of the second RACH message may for example be made after a timer expires. In embodiments, in response to a predetermined period of time passing after transmittal of the first RACH message without receipt of a RRC connection setup message, the UE causes re-transmission of the second associated RACH message; in such embodiments, a second or further subsequent transmission of the second RACH message may for example be made after a timer expires. For example, in the case of a delay tolerant service, the UE may need to retransmit the second associated RACH message in case a resource is not allocated immediately or quickly enough.

In embodiments, the first RACH message comprises a cell update message.

In embodiments, the first RACH message comprises data associated with one or more security parameters for initializing secure data transfer. In such embodiments, the second associated RACH message may for example comprise data encrypted according to the one or more security parameters. In embodiments, in response to receipt of the second associated RACH message comprising the encrypted data, the network node generates 112 and transmits 114 an acknowledgement message acknowledging receipt of the encrypted data to the user equipment.

In embodiments, the first RACH message comprises a newly defined message used to indicate the connection request type, the identifier, and can also be used to transmit some security information to initialize secure data transfer (e.g. key, start value, etc.). The first RACH message could also comprise an existing RRC Connection Request which uses a new establishment cause and/or spare value to indicate further RACH data is to be transmitted. In embodiments, the second associated RACH message contains the secure data and an ID) to link the second associated RACH message to the first RACH message. Such embodiments avoid the NW node having to allocate any dedicated resource to the UE at all, since all the messages are transmitted on UI, common RACH channel. i.e. the implementation is truly “connection-less”. Further, the UE does not need to indicate a “connection ID” to the NW node, because this can be stored in the NW and derived from the UE identity which is already transmitted according to embodiments.

Embodiments may particularly be applicable for UTRAN, whereby it is possible to send enough data on RACH/CCCH. For EUTRAN, the existing messages are very small, and so there may be a need for additional UL, common resources defined for sending small data and accommodating larger RRC messages. For the EUTRAN case, the first RACH message may be transmitted on an existing UL resource and the second associated RACH message may be transmitted on a second resource. In UTRAN, the existing PRACH or common E-DCH may for example be used.

In embodiments, the first RACH message comprises an indication that unsecure data is to follow in at least the second associated RACH message. In such embodiments, the second associated RACH message may for example comprise at least some of the unsecure data indicated in the first RACH message.

In embodiments, the first RACH message is transmitted by the UE on a first uplink RACH resource and the second associated RACH message is transmitted by the UE on a second, different uplink RACH resource.

Embodiments comprise the UE determining a size of payload data which is required to be transmitted on a RACH from the user equipment. In such embodiments, in response to the determined payload data size exceeding a predetermined threshold, the generation of the first RACH message by the UE comprises inserting a first part of the payload data into the first RACH message. In embodiments, the generation of the second associated RACH message by the UE comprises inserting a second part of the payload data into the second associated RACH message. In embodiments, the payload data is required to be transmitted on the RACH from the user equipment in relation to a connection establishment or cell update procedure.

In embodiments, when the UE initiates connection establishment or cell update procedure, the UE checks the size of the data which is to be transmitted in the UL and decides whether to split the data for transmittal in a sequence of two or more RACH messages. In alternative embodiments, the UE always splits the data which is to be transmitted in the UL into two or more RACH messages without performing a check of the size of the data.

Embodiments comprise the UE determining a size of payload data which is required to be transmitted on a RACH from the user equipment. In such embodiments, in response to the determined payload data size exceeding a predetermined threshold, the generation of the first RACH message by the UE comprises inserting none of the payload data into the first RACH message, and the generation of the second RACH message by the UE comprises inserting at least part of the payload data into the second RACH message. In embodiments, the generation of the first RACH message by the UE comprises inserting data associated with one or more communication capabilities of the UE and/or data associated with one or more security parameters for initializing secure data transfer into the first RACH message.

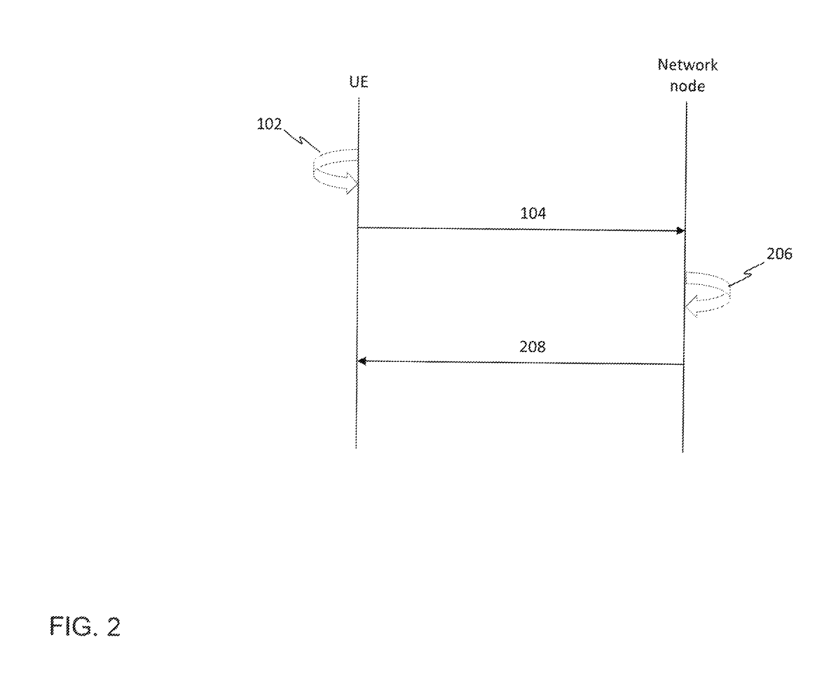

FIG. 2 shows a message flow diagram according to embodiments. Items 102 and 104 in FIG. 2 involve similar processes to items 102 and 104 described above in relation to FIG. 1 such that a first RACH message arrives at the network node which comprises an indication that at least a second RACH message associated with the first RACH message is to be transmitted subsequently from the UE on the RACH.

However, in the embodiments of FIG. 2, the network node decides 206 to setup a connection with the UE without waiting for receipt of the second associated RACH message.

In embodiments, the first RACH message comprises a RRC connection message, and in response to receipt of the first RACH message, the network node transmits a RRC connection setup message to the UE. In embodiments, the network node transmits 208 the RRC connection setup message prior to receipt of the second associated RACH message from the UE which was indicated in the first RACH message. In embodiments, in response to receipt of the RRC connection setup message, the UE cancels transmittal of the second associated RACH message.

In the embodiments of FIG. 2, the UE transmits the first RACH message to the NW node. Based on the first RACH message, the NW node is able to set up any necessary connection on a current cell (e.g. a packet-switch (PS) data call, a circuit-switched (CS) voice call, etc.) based on the transmitted UE capabilities.

In embodiments, the NW node may have a policy to perform redirection or handover to another cell or frequency or RAT, based on UE measurements provided in the second RACH message (e.g. in the case of load balancing or a service specific frequency layer) then the NW will wait for the second RACH message containing the necessary measurement information.

In embodiments, the NW node does not require measurements from the UE and the NW node may choose not to allocate a resource to the UE. In embodiments, the UE can then cancel transmittal and/or stop re-transmittal of the second associated RACH message when a RRC Connection Setup messages is received from the NW node.

Embodiments allow ‘small data’ (such as MTC small data) to be sent without the need to allocate dedicated resources. Such small data can be encrypted by sending security parameters and encrypted data in separate associated RAC messages according to embodiments.

Embodiments allow RACH measurement results to be sent separately, thus avoiding any message size limitation and allowing resource setup on the current cell without any additional delay due to RACH measurement overhead (in RRC message size).

In embodiments, there is no need to synchronize timing of the first and second associated RACH messages (and possibly further associated RACH messages), as the messages can be paired by the NW node using an identity in each message. Further, this means that in the case of re-transmission (for example due to bad radio conditions). NW overload, and/or contention detection, the RACH message order does not matter.

By employing embodiments. RACH message size is no longer an issue when using R99 PRACH channel.

Embodiments may involve a short delay before the NW node obtains relevant measurements from the UE; due to such a short delay, more measurements will be available allowing the NW to manage resources more efficiently.

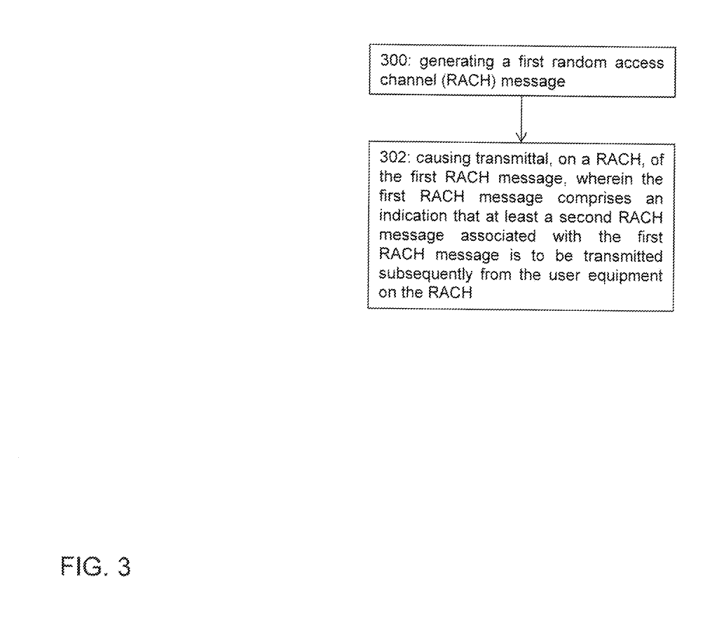

FIG. 3 shows a flow diagram according to embodiments. In particular, FIG. 3 depicts measures for use in radio resource control in a cellular telecommunications network from the perspective of a UE.

Item 300 comprises the UE generating a first random access channel (RACH) message.

Item 302 comprises the UE causing transmittal, on a RACH, of the first RACH message.

The first RACH message comprises an indication that at least a second RACH message associated with the first RACH message is to be transmitted subsequently from the user equipment on the RACH.

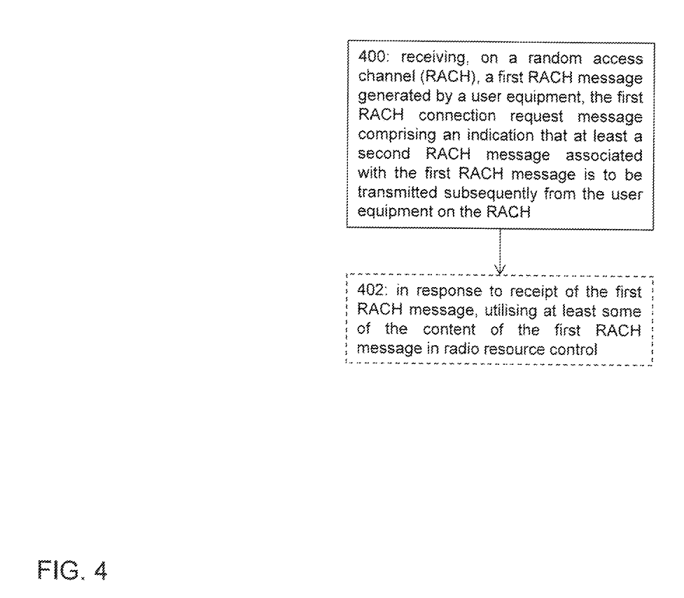

FIG. 4 shows a flow diagram according to embodiments. In particular, FIG. 4 depicts measures for use in radio resource control in a cellular telecommunmications network from the perspective of a NW node.

Item 400 comprises the NW node receiving, on a random access channel (RACH), a first RACH message generated by a user equipment, the first RACH connection request message comprising an indication that at least a second RACH message associated with the first RACH message is to be transmitted subsequently from the user equipment on the RACH.

Item 402 comprises the NW node, in response to receipt of the first RACH message, utilizing at least some of the content of the first RACH message in radio resource control. Item 402 depicts an optional step (hence, the 402 box has a dashed as opposed to a solid line).

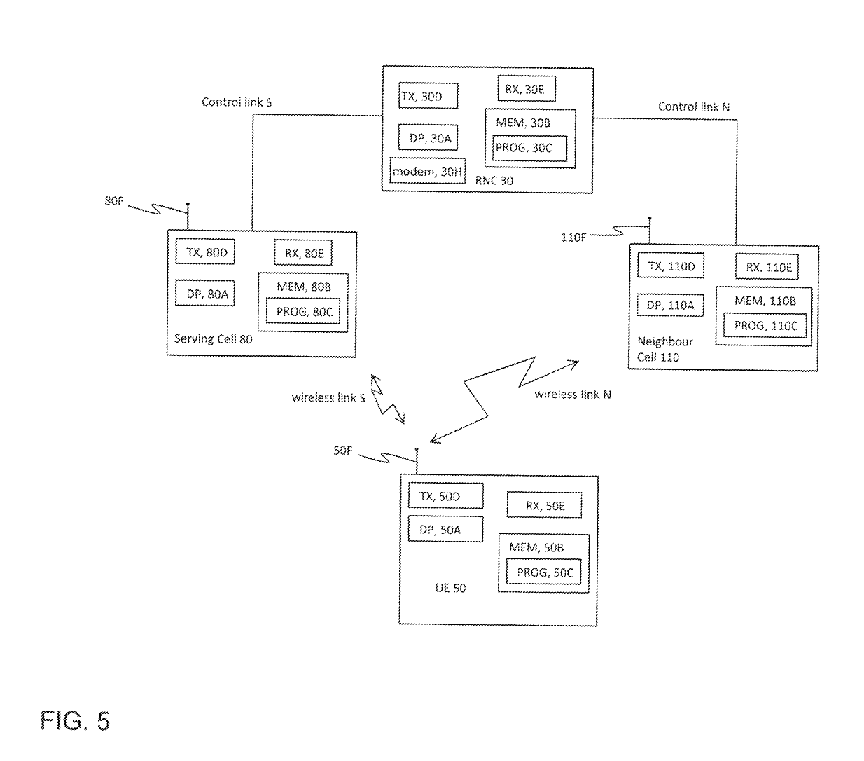

FIGS. 3 and 4 represent results from executing a computer program or an implementing algorithm stored in the local memory of UE 50 (see FIG. 5 and corresponding description below) or a NW node (such as RNC 30 or serving cell 80) respectively as well as illustrating the operation of a method and a specific manner in which the processing system and/or processor and memory with computer program/algorithm are configured to cause one or more of UE 50, serving cell 80, and RNC 30 respectively (or one or more components thereof) to operate. The various blocks shown in these figures may also be considered as a plurality of coupled logic circuit elements constructed to carry out the associated function(s), or specific result or function of strings of computer program code stored in a computer readable memory. Such blocks and the functions they represent are non-limiting examples, and may be practiced in various components such as integrated circuit chips and modules, and that embodiments of the present invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with embodiments of the present invention.

Reference is now made to FIG. 5 which illustrates a simplified block diagram of various example electronic devices and/or apparatus that are suitable for use in practicing embodiments of the present invention. In FIG. 5, serving cell 80 is adapted for communication over a wireless link S with a UE 50, such as a mobile terminal. Similarly, a neighbour cell 110 is adapted for communication over a wireless link N with UE 50. Serving cell 80 and/or neighbour 110 each may comprise a macro Node B, an eNodeB, a remote radio head, relay station, a femto cell or home NodeB, or other type of base station/cellular network access node.

UE 50 may include processing means such as a processing system and/or at least one data processor (DP) 50A, storing means such as at least one computer-readable memory (MEM) 50B storing at least one computer program (PROG) 50C, and also communicating means such as a transmitter TX 50D) and a receiver RX 50E for bidirectional wireless communications with the serving cell 80 and/or neighbour cell 110 and/or any other further neighboring cells (not shown) via one or more antennas 50F. Note that embodiments may be carried out by apparatus such as a modem which does not comprise an antenna.

Serving cell 80 includes its own processing means such as a processing system and/or at least one data processor (DP) 80A, storing means such as at least one computer-readable memory (MEM) 80B storing at least one computer program (PROG) 80C, and communicating means such as a transmitter IX 801) and a receiver RX 80E for bidirectional wireless communications with other devices under its control via one or more antennas 80F. There is a data and/or control path, termed at FIG. 5 as a control link S which in the 3GPP cellular system may be implemented as an Iub interface or in E-UTRAN as an SI interface, coupling the serving cell 80 with RNC 30, and over which RNC 30 and serving cell 80 may exchange control messages, such as system information update requests and/or change notifications. RNC 30 may alternatively or in addition comprise a Mobility Management Entity (MME), or suchlike.

Similarly, neighbour cell 110 includes its own processing means such as a processing system and/or at least one data processor (DP) 110A, storing means such as at least one computer-readable memory (MEM) 110B storing at least one computer program (PROG) 110C, and communicating means such as a transmitter TX 110D and a receiver RX 110E for bidirectional wireless communications with other devices under its control via one or more antennas 110F. There is a data and/or control path, termed at FIG. 5 as a control link N which in the 3GPP cellular system may be implemented as an Iub interface or in E-UTRAN as an S1 interface, coupling the neighbour cell 110 with RNC 30, and over which RNC 30 and neighbour cell 110 may exchange control messages, such as system information update requests and/or change notifications.

RNC 30 includes processing means such as a processing system and/or at least one data processor (DP) 30A, storing means such as at least one computer-readable memory (MEM) 30B storing at least one computer program (PROG) 30C, and communicating means such as a modem 3011 for bidirectional communication with serving cell 80 over control link S, with neighbour cell 110 over control link N, or other network nodes (not shown).

While not particularly illustrated for UE 50, serving cell 80, neighbour cell 110 and RNC 30, any of those devices/entities/elements may include as part of wireless communicating means a modem which may be inbuilt on a RF front end chip within those devices 50, 80, 110 30 and which chip also carries the TX 50D/80D/110D/30) and the RX 50E/80E/110E/30E.

Various embodiments of UE 50 can include, but are not limited to: mobile telephones (or ‘cellular’ telephones) including so-called smartphones; data cards, USB dongles, laptop computers, personal portable digital devices having wireless communication capabilities including but not limited to laptop/palmtop/tablet/phablet computers, digital cameras and music devices, Internet appliances, and machine type devices such as smart meters, smart sensors, vending machines, gaming machines, point of sale machines, etc.

At least one of the PROGs 50C in UE 50 is assumed to include program instructions that, when executed by the associated DP 50A, enable the device to operate in accordance with embodiments of the present invention, as detailed above. Serving cell 80, neighbour cell 110 and RNC 30 also have software stored in their respective MEMs to implement certain aspects of these teachings. In these regards, embodiments of this invention may be implemented at least in part by computer software stored on the MEM 50B, 8013, 110B, 3013 which is executable by the DP 50A of UE 50, DP 80A of serving cell 80, DP 110A of neighbour cell 110 and/or DP 30A of RNC 30, or by hardware, or by a combination of tangibly stored software and hardware (and tangibly stored firmware). Electronic devices implementing these aspects of the invention need not be the entire devices as depicted at FIG. 5, but embodiments may be implemented by one or more components of same such as the above described tangibly stored software, hardware, firmware and DP, or a system on a chip SOC, an application specific integrated circuit ASIC or a digital signal processor DSP.

Various embodiments of the computer readable MEMs 50B, 80B, 110B and 30B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 50A, 30A, 110A and 80A include but are not limited to general purpose computers, special purpose computers, microprocessors, digital signal processors (DSPs) and multi-core processors.

The above embodiments are to be understood as illustrative examples of the invention. Further embodiments of the invention are envisaged.

The term embodiment herein should be taken to mean an example and the term embodiments herein should be taken to mean some examples, such that description of an embodiment or embodiments refers to some embodiments, but not necessarily all embodiments.

In embodiments described above, the UE generates the first RACH message separately to generating the second associated RACH message. In alternative embodiments, the UE generates the first and second associated RACH messages together.

In embodiments described above, the NW node carries out various data processing tasks. In alternative embodiments, the NW node may initiate one or more such tasks and be assisted by one or more other network entities in performing those tasks. In further alternative embodiments, some of the tasks of the NW node are carried out by multiple nodes, for example some tasks are carried out by an eNB and other tasks are carried out by an RNC.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

### LIST OF ACRONYMS AND ABBREVIATIONS

3GPP 3rd Generation Partnership Project
CCCH Common Control Channel
CS Circuit-Switched
E-UTRAN Evolved-UTRAN
IE Information Element
LTE Long Term Evolution
LTE-A Long Term Evolution Advanced
NW Network
MAC Medium Access Control
MBMS Multimedia Broadcast and Multicast Service
MTC Machine Type Communication
PRACH Physical Random Access Channel
PS Packet-Switched
R99 3GPP Release 1999
RACH Random Access Channel
RAT Radio Access Technology
Rel-12 3GPP Release 12
RNC Radio Network Controller
RRC Radio Resource Control
TR Technical Report
UE User Equipment
UL Uplink
UTRAN UMTS Terrestrial Radio Access Network

1. A method for use in radio resource control in a cellular communications network, the method comprising, at a user equipment:
generating a first random access channel (RACH) message; and
causing transmittal, on a RACH, of the first RACH message,
wherein the first RACH message comprises an indication that at least a second RACH message associated with the first RACH message is to be transmitted subsequently from the user equipment on the RACH.

2. A method according to claim 1, wherein the first RACH message comprises an identifier identifying at least one of:
at least the first RACH message and the second associated RACH message as being a sequence of RACH messages; and
the user equipment.

3-32. (canceled)

33. An apparatus for use in radio resource control in a cellular communications network, the apparatus comprising a processing system, the processsing system comprising at least one processor and at least one memory storing a computer program, in which the processing system is configured to, at a user equipment:
generate a first random access channel (RACH) message; and
cause transmittal, on a RACH, of the first RACH message,
wherein the first RACH message comprises an indication that at least a second RACH message associated with the first RACH message is to be transmitted subsequently from the user equipment on the RACH.

34. The apparatus according to claim 33, wherein the first RACH message comprises an identifier identifying at least one of:
at least the first RACH message and the second associated RACH message as being a sequence of RACH messages; and
the user equipment.

35. (canceled)

36. The apparatus according to claim 34, wherein the identifier identifies how many RACH messages are in the sequence of RACH messages.

37. The apparatus according to claim 33, wherein the first RACH message comprises data associated with one or more communication capabilities of the user equipment.

38. The apparatus according to claim 33, the processing system being configured to, at the user equipment:
generate the second associated RACH message; and
cause transmittal of the generated second associated message on the RACH.

39. The apparatus according to claim 34, wherein the second associated RACH message comprises at least one of:
the identifier; and
data associated with one or more measurements performed by the user equipment.

40-42. (canceled)

43. The apparatus according to claim 33, wherein the first RACH message comprises a radio resource control (RRC) connection request message.

44. The apparatus according to claim 38, the processing system being configured to, at the user equipment, in response to transmittal of the second associated RACH message, receive either a RRC connection reject message or a RRC connection setup message.

45. (canceled)

46. The apparatus according to claim 44, wherein one or more of the RRC connection reject message and the RRC connection setup message comprises data associated with a redirection or handover to a different cell, carrier frequency or radio access technology.

47. The apparatus according to claim 38, the processing system being configured to, at the user equipment, in response to a predetermined period of time passing after transmittal of the first RACH message without receipt of a RRC connection setup message, cause re-transmission of the second associated RACH message.

48. The apparatus according to claim 33, the processing system being configured to, at the user equipment, in response to transmittal of the first RACH message, receive a RRC connection setup message.

49. The apparatus according to claim 48, the processing system being configured to, at the user equipment, in response to receipt of the RRC connection setup message, cancel transmittal of the second associated RACH message.

50. The apparatus according to claim 33, wherein the first RACH message comprises a cell update message.

51. The apparatus according to claim 33, wherein the first RACH message comprises an establishment cause indicator indicating the cause of generation of the first RACH message and/or the second associated RACH message.

52. The apparatus according to claim 33, wherein the first RACH message comprises data associated with one or more security parameters for initializing secure data transfer.

53. The apparatus according to claim 38, wherein the second associated RACH message comprises data encrypted according to the one or more security parameters.

54. (canceled)

55. The apparatus according to claim 33, wherein the first RACH message comprises an indication that unsecure data is to follow in at least the second associated RACH message.

56-131. (canceled)

132. A non-transitory computer-readable storage medium having computer readable instructions stored thereon, the computer readable instructions being executable by a computerized device to cause the computerized device to perform:
generating a first random access channel (RACH) message; and
causing transmittal, on a RACH, of the first RACH message,
wherein the first RACH message comprises an indication that at least a second RACH message associated with the first RACH message is to be transmitted subsequently from the user equipment on the RACH.
